(19) United States
(12) Patent Application Publication
(10) Pub. No.: US 2006/0226581 A1
(43) Pub. Date: Oct. 12, 2006

(54) Method for reforming a thermoplastic weatherstrip

(75) Inventor: Walter J. Kelly, Howell, MI (US)

Correspondence Address: BRINKS HOFER GILSON & LIONE, P.O. BOX 10395, CHICAGO, IL, 60610, US

(73) Assignee: GDX North America Inc.

(21) Appl. No.: 11/102,980

(22) Filed: Apr. 11, 2005

(51) Int. Cl. B29C 53/00

(52) U.S. Cl. 264/492; 264/285; 264/339

(57) ABSTRACT

A method of reforming a thermoplastic elastomeric composite weatherstrip for a window opening of a motor vehicle comprises the steps of fabricating the weatherstrip through extrusion, molding or other conventional means, heating a section of the weatherstrip to be reformed, applying and conforming the heated section to a curved form or fixture having an included angle greater than the desired final configuration, cooling the weatherstrip while maintaining contact with the fixture and aging the formed weatherstrip to achieve angular equilibrium. The resulting weatherstrip product is also disclosed and claimed.

### TECHNICAL FIELD OF THE INVENTION

The invention relates to a method of fabricating a motor vehicle weatherstrip and more particularly to a method for reforming a thermoplastic elastomer composite weatherstrip and the resulting weatherstrip.

### BACKGROUND OF THE INVENTION

Generally speaking, motor vehicles are equipped with moveable windows that slide in a window frame between a closed position wherein the window closes and seals an opening and an open position wherein the window is retracted within a door or body panel and allows the entry of air into or exhaust of air from the passenger compartment. Weatherstrip is disposed about the periphery of the window opening and provides an airtight and watertight seal between the window glass and the window frame. One type of weatherstrip, referred to as an edge seal, defines a groove that slidably receives a window edge and includes surfaces that form a seal against the window. Another type of weatherstrip, referred to as a beltstrip, is disposed adjacent the window on the exterior of the vehicle where the window retracts into the door or body panel and includes a wiper flange that wipes the surface of the window as it is retracted or raised.

Weatherstrips perform both an aesthetic function and a mechanical function. Aesthetically, the weatherstrip provides an interface between the window and door or body panel and must therefore present an attractive appearance. Additionally, of course, the weatherstrip must achieve an air and watertight seal between the window glass and door or body panel. It should also be understood that the weatherstrip must provide a desirable, typically smooth, aerodynamic shape as this minimizes wind noise and lowers the coefficient of drag of the vehicle.

These goals suggest that minimizing the number of weatherstrip components around a given window opening would be desirable. While this is true, achieving a unitary gasket ignores not only the different roles of beltstrips and edge seals but also ignores the complex window shapes and door configurations in which the weatherstrips must function. For example, a right angle corner, between the door header and the vehicle B pillar typically requires two mitered edge seal pieces. The use of two separate pieces complicates installation and may result in gaps between the edge seal ends which may compromise the seal. An obvious alternative involves gluing or heat sealing the mitered ends of the edge seals together. In such an assembly, even if properly adhered to one another, the mitered and adhered ends generally represent a weak spot where failure may eventually occur. If not properly adhered they may be a site of air and water leakage.

While many window/door panel corners may be curved, fitting a straight and unformed section of edge seal into a curved window opening invariably results in wrinkling and misshapen edge seal components, particularly in the inside of the edge seal which is that region which accepts the window glass. Thus, while eliminating a junction between two ends of edge seal, conforming a straight edge seal to the contour of a curved window opening is also accompanied by installation and service difficulties.

The present invention relates to a method of reforming a motor vehicle weatherstrip, specifically an edge seal, and addresses and solves the foregoing problems.

### SUMMARY OF THE INVENTION

In accordance with this invention, a method of reshaping or reforming a thermoplastic elastomeric composite weatherstrip for a window opening of a motor vehicle comprises the steps of fabricating the weatherstrip through extrusion, molding or other conventional means, heating a section of the weatherstrip to be reformed, applying and conforming the heated section to a curved form or fixture having an included angle greater than the desired final configuration, cooling the weatherstrip while maintaining contact with the fixture and aging the formed weatherstrip to achieve angular equilibrium. The weatherstrip may thus be fabricated to accurately complement one or more curved window and door or body panel corners. The resulting weatherstrip product is also disclosed.

Thus it is an object of the present invention to provide a method for providing a motor vehicle weatherstrip which accurately fits a curved corner in a window opening of a door or body panel.

It is a further object of the present invention to provide a method for reforming a thermoplastic elastomer composite weatherstrip.

It is a still further object of the present invention to provide a method for reshaping or reforming a thermoplastic elastomer weatherstrip into a shape which closely matches a profile of a motor vehicle door or body panel window opening.

It is a still further object of the present invention to provide a reshaped or reformed motor vehicle weatherstrip which closely matches the curved of a window opening in a door or body panel of a motor vehicle.

Further objects and advantages of the present invention will become apparent by reference to the following description of the preferred embodiment and appended drawings wherein the like reference numbers refer to the same component, element or feature.

### BRIEF DESCRIPTION OF THE DRAWINGS

FIG. 1 is a fragmentary, side elevational view of a motor vehicle incorporating the present invention;

FIG. 2 is an enlarged, cross-section of a motor vehicle weatherstrip for use with the present invention taken along line 2-2 of FIG. 1;

FIG. 3 is a diagrammatic view of the fabrication by extrusion of a weatherstrip for the present invention;

FIG. 4 is a diagrammatic view of the weatherstrip heating step of a method according to the present invention;

FIG. 5 is a top plan view of a forming fixture for use with the present invention;

FIG. 6 is a diagrammatic view of the weatherstrip forming step of a method according to the present invention;

FIG. 7 is a diagrammatic view of the weatherstrip cooling step of a method according to the present invention; and

FIG. 8 is a diagrammatic view of the weatherstrip aging step of a method according to the present invention.

### DETAILED DESCRIPTION OF THE INVENTION

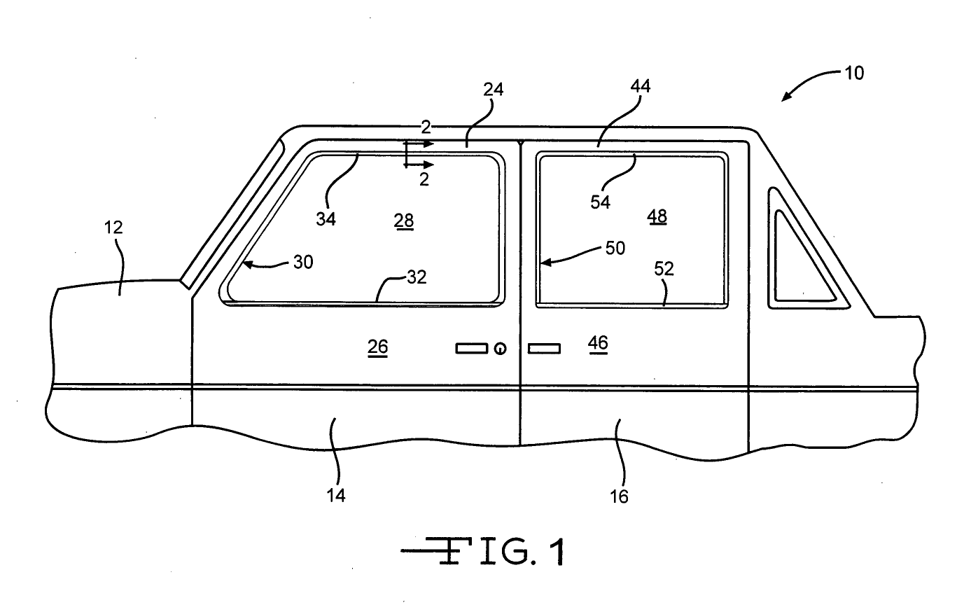

Referring now to FIG. 1, a typical consumer motor vehicle such as a passenger car, pick-up truck, sport utility vehicle (SUV), or station wagon is illustrated and designated by the reference number 10. The motor vehicle 10 includes a body 12. The motor vehicle body 12 typically includes front doors 14, one of which is illustrated in FIG. 1, and rear doors 16, one of which is also illustrated in FIG. 1. Each of the front doors 14 includes an upper frame assembly 24 and a front lower door panel 26 which generally defines a front opening which receives a front window or glass light 28. About the periphery of the glass receiving opening is a front weatherstrip assembly 30. Likewise, the rear door 16 includes a rear upper frame assembly 44 and a rear lower door panel 46 which define an opening which receives a rear window or glass light 48. Once again, the glass receiving opening is trimmed with and receives a rear weatherstrip assembly 50. Both the front and rear window weatherstrip assemblies 30 and 50 will generally include a belt strip 32 and 52, respectively, which extends across the lower portion of the window opening and the upper portion of the door panels 26 and 46, respectively, to form an interface between the front and rear lower door panels 26 and 46 and the respective glass lights 28 and 48. The weatherstrip assemblies 30 and 50 also include front and rear edge seals 34 and 54 which acts as an interface between the front and rear glass lights 28 and 48 and the respective door frames 24 and 44.

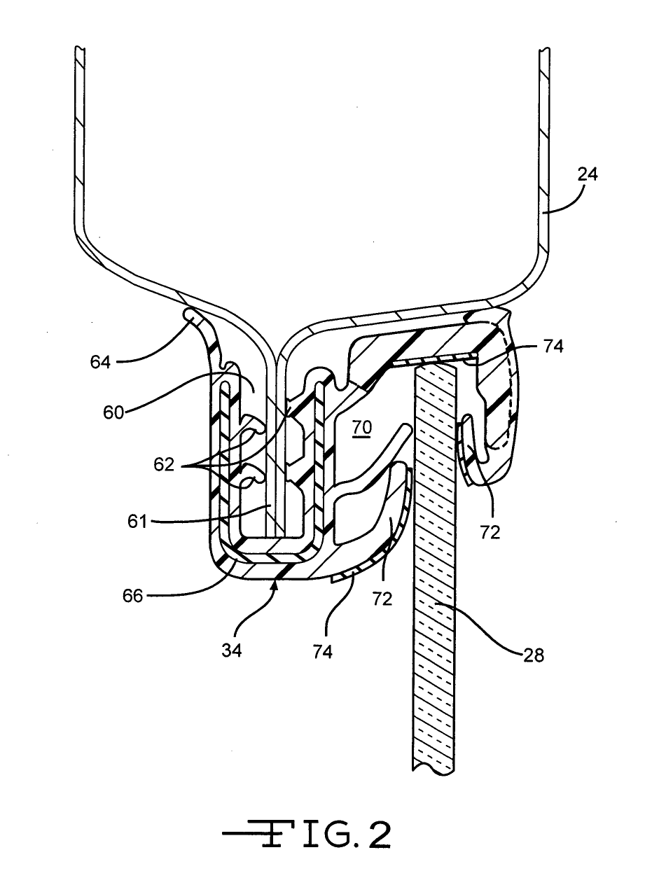

Referring now to FIG. 2, the front edge seal 34 defines a generally S-shaped body having a first channel 60 which receives a flange 61 of the upper frame assembly 24 thereby retaining and securing the edge seal 34 to the upper door frame assembly 24 of the front door 14. Assisting such retention is a plurality of projecting, opposed lips or flanges 62 which engage the flange 61 of the door frame assembly 24. A continuous terminal lip portion 64 engages and seals against the door frame assembly 24 and exhibits sufficient flexibility to accommodate dimensional variations in, for example, the size of the flange 61 to provide an aesthetically attractive seal. A wound, coiled, slotted or perforated metal insert 66 provides strength, shape and rigidity to the weatherstrip 64 and is preferably fully embedded or surrounded by the thermoplastic material of the edge seal 34.

The edge seal 34 also includes a second channel 70 which receives the glass light 28. At the mouth of the second channel 70 are a plurality of obliquely oriented flanges or wipers 72 which engage the glass light 28 and seal there-against. The surfaces of the flanges or wipers 72 and the base of the second channel 70 may include a low friction material 74 such as flocking, a thermoplastic coating or a thin layer of a polymer resin such as Teflon. Teflon is a registered trademark of the E.I. DuPont deNemours Co. for its brand of fluropolymer resin. Other polyolefin based materials such as polyethylene and polypropylene may also be used.

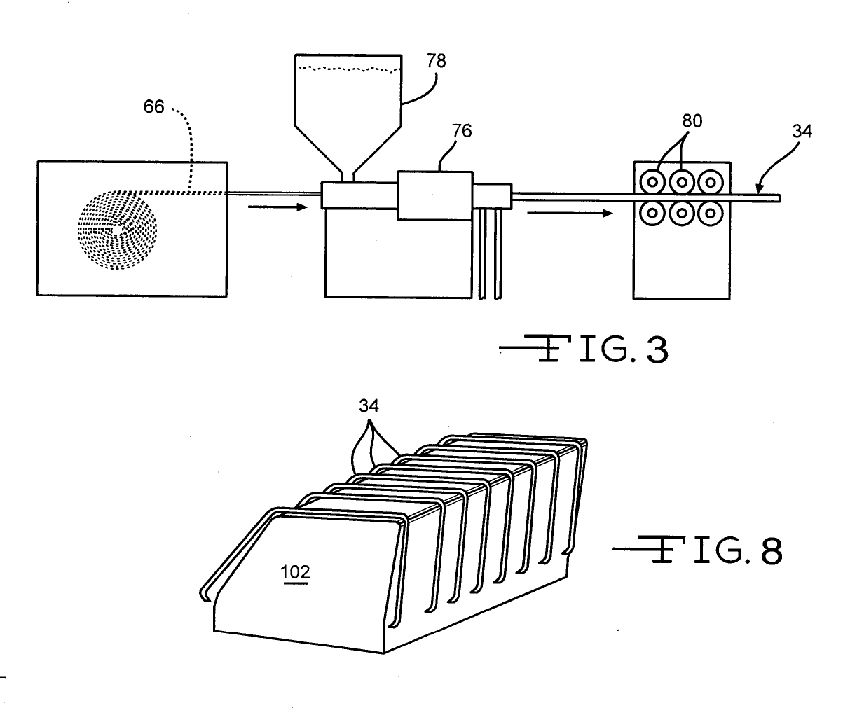

Referring now to FIG. 3, fabrication of the edge seal 34 by an extrusion process is illustrated. An extruding machine 76 having conventional material heating, extruding and cooling stations includes a hopper 78 filled with a suitable thermoplastic material and receives the wound, coiled, slotted or perforated insert 66. The thermoplastic material is heated, formed about the insert 66 in a suitably shaped extrusion die (not illustrated) and is cooled while passing through a series of forming dies to attain its final form after exiting the extruding machine 76. Preferably, the edge seal 34 is passed through a series of rollers 80 which straighten the edge seal 34. The edge seal 34 is preferably fabricated of a thermoplastic elastomer (TPE) or a thermoplastic vulcanizate (TPV). Although the edge seal 34 is preferably fabricated by extrusion, it may also be made by any suitable molding or forming operation.

It will be appreciated that the edge seal 34 illustrated is exemplary in nature and that the method disclosed and claimed herein may be practiced with weatherstrips and edge seals having various and sundry specific configurations. They will, however, generally define the S-shape disclosed herein which receives, in oppositely directed channels, a mounting flange extending from the vehicle or vehicle door and a moveable glass light.

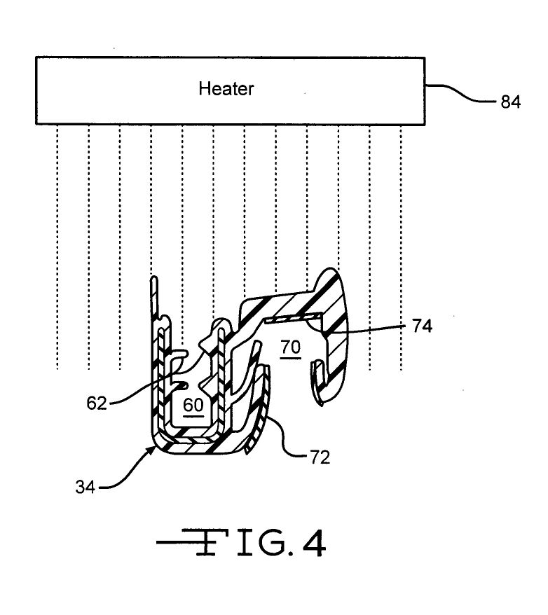

Referring now to FIG. 4, the edge seal 34, which has, as noted above, been fabricated by extrusion or other process, is placed in proximity to an infrared heater 84 which heats a length, typically between four and six inches (102 mm to 152 mm) and preferably about 5 inches (127 mm) of the edge seal 34. The edge seal 34 is heated to a temperature of between 250° and 290° Fahrenheit (121° C. to 143° C.) and preferably between 265° and 270° Fahrenheit (129° C. to 132° C.) for two to four minutes and preferably about three minutes such that the thermoplastic material of the edge seal 34 is well heated and softened but not so high in temperature or heated for so long a time that the thermoplastic material begins to melt. The heat is applied to the base of the edge seal 34 forming the second slot 70 for the glass light 28. As noted, the heat is preferably provided by an infrared heater 84 such as a quartz lamp electric heater although a forced air (convection) heater or a combination of radiant and convection heating may also be utilized. Although the heating of only a single length of the edge seal 34 has been shown, it will be appreciated that two (or more) regions of the edge seal 34 may be heated simultaneously in order to perform and achieve two (or more) curved regions of the edge seal 34 as may be routinely encountered in a typical window installation, i.e. the curved corners at the front and rear intersections of the upper horizontal window frame with vertical or oblique members.

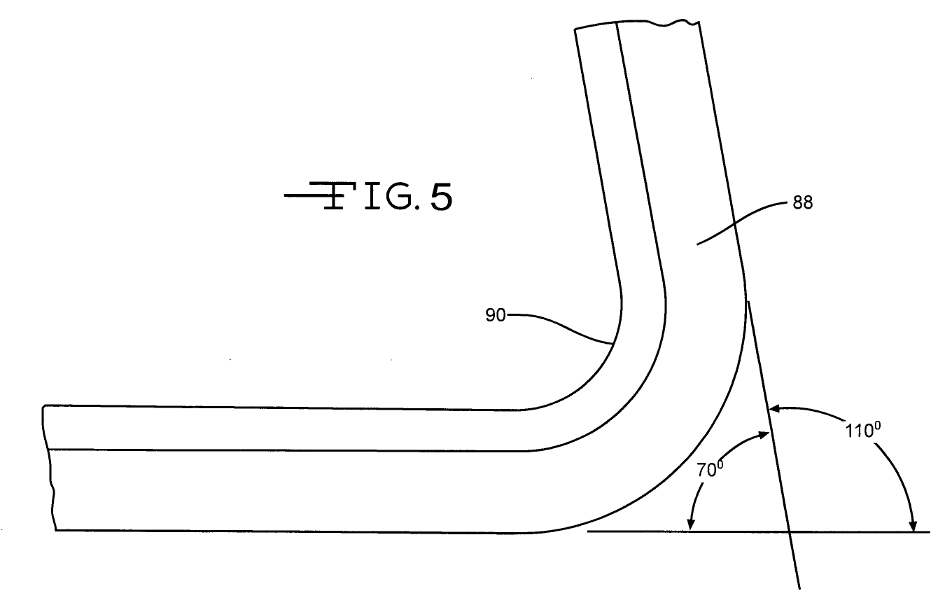

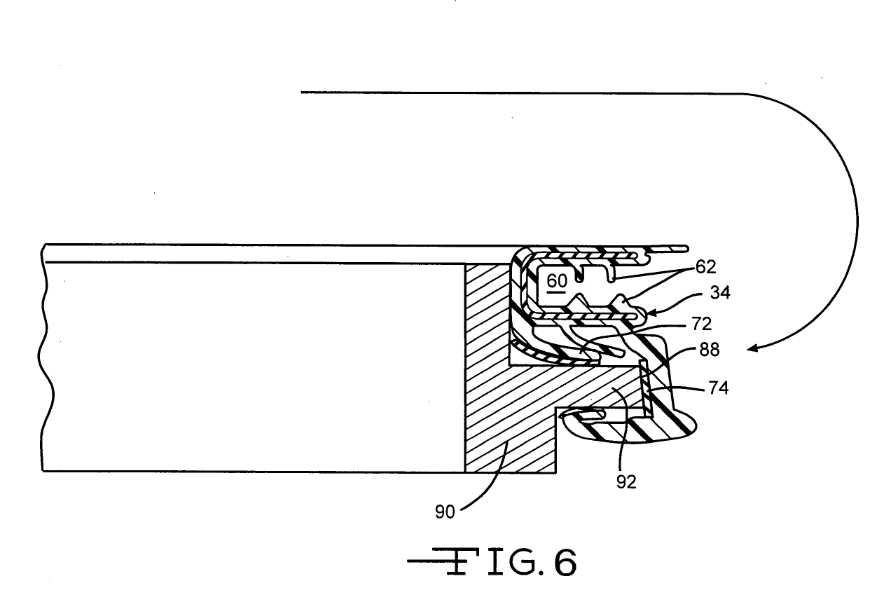

As illustrated in FIGS. 5 and 6, the edge seal 34 having a heated section of, as noted, between four and six inches and, in any event, a length corresponding to the total involved length of a curved corner such as that illustrated in FIG. 1 is then tightly disposed about the peripheral forming edge 88 of a curved rail or fixture 90. The fixture 90 includes a curved peripheral projection 92 having a projecting distance nominally equal to the depth of the slot 70. Thus, when the edge seal 34 is placed firmly on the fixture 90, the forming edge 88 of the projection 92 engages the bottom surface of the slot 70 and thereby closely conforms the heated portion of the edge seal 34 to the precise radii of curvature of the fixture 90 and the projection 22 and to the shape desired. Because of springback or hysteresis, the extent of curvature of the fixture 90 (in degrees) will typically and preferably be greater than the desired final curvature. That is, if as is typical, a 90° bend is desired to conform to the change from a horizontal section of the door frame to a vertical section, the edge seal 34 must be initially bent or formed to an angle typically 20° to 40° greater. Because of springback or hysteresis, therefore, to make a 90° bend it is generally necessary to extend the curved portion of the edge seal 34 beyond 90° and typically to 110°, 120°or 130° measured as an obtuse angle (or 70°, 60°, 50° measured as an acute angle), depending upon the springback experienced or displayed by a particular edge seal 34.

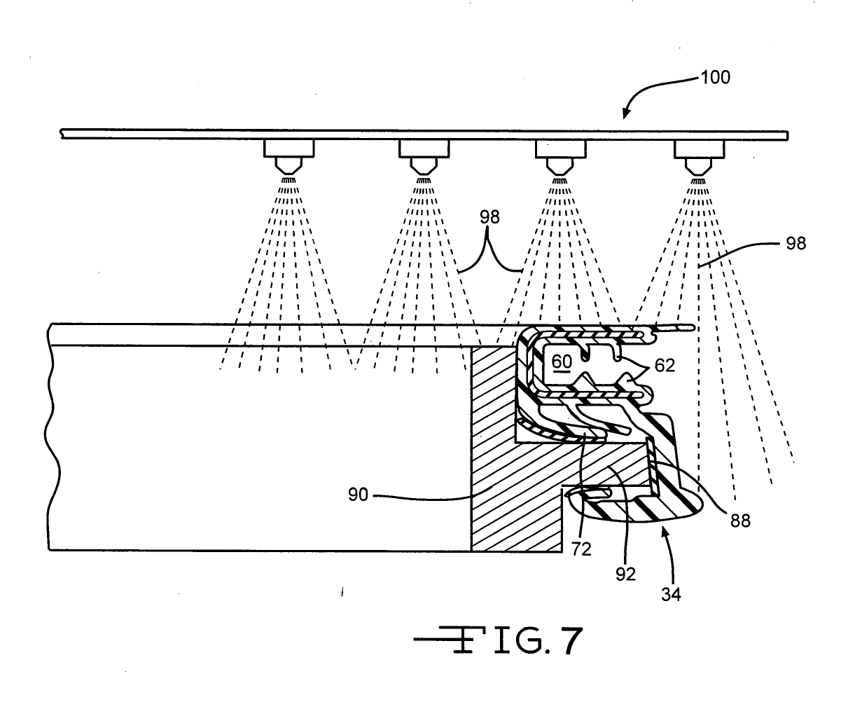

Referring now to FIG. 7, the edge seal 34 is maintained on the forming edge 88 of the rail or fixture 90 and is then subjected to spray 98 from a water spray apparatus 100. The water spray 98 cools the edge seal 34 to a temperature of approximately 65° to 75° Fahrenheit (19° to 24° Centigrade). Alternatively, the edge seal 34 may be cooled by chilled air or any other means capable of lowering the temperature of the edge seal 34 to approximately room temperature in a relatively short period of time.

In the forming step, the uncross-linked hydrocarbon chains of the thermoplastic material are stretched and reformed. During the cooling step these chains are fixed in their stretched positions such that the edge seal 34 generally takes on the curved shape of the rail or fixture 90.

Finally, and with reference now to FIG. 8, the formed and cooled edge seals 34 are placed on a rack 102 to reach angular equilibrium. As stated above, due to springback or hysteresis, the edge seal 34 is over-formed, i.e., formed to an angle in excess of the typical right angle (90°) or other angle such as between the vehicle A pillar and the top of a door desired. During the racking and equilibrium step, the edge seal 34 though initially formed at, for example, 110° or 115° will relax over several hours or longer to an angle very near or consistent with the desired angle such that the shapes and contour of the edge seal 34 conforms closely to both the corner of a window and the vehicle door or body.

While this invention has been described in terms of certain embodiments thereof, it is not intended to be so limited, but rather should be limited only to the extent set forth in the claims that follow.

1. A method of reshaping a weatherstrip, comprising the steps of:
providing a length of weatherstrip;
heating a portion of said weatherstrip,
providing a fixture having a curved exterior surface,
conforming said heated portion of said weatherstrip to at least a portion of said surface of said fixture,
cooling said weatherstrip while in contact with said surface of said fixture.

2. The method of claim 1 wherein said heating is achieved by an infrared heater.

3. The method of claim 1 wherein said curved exterior surface portion of said fixture extends over at least 120°.

4. The method of claim 1 wherein said cooling is achieved by water spray.

5. The method of claim 1 wherein said weatherstrip has a first slot for receiving a window and a second opposed, adjacent slot for receiving a flange.

6. The method of claim 1 further including the step of aging said reshaped weatherstrip.

7. The method of claim 1 wherein said weatherstrip includes a slot adapted to receive a glass light and said fixture includes a projection which extends to a bottom of said slot when surfaces of said weatherstrip adjacent said slot are in contact with said curved exterior surface.

8. A method of reforming a weatherstrip, comprising the steps of:
heating a length of said weatherstrip,
providing a fixture having a curved exterior surface,
conforming said weatherstrip to at least a portion of said curved exterior surface of said fixture,
cooling said weatherstrip while in contact with said curved exterior surface of said fixture.

9. The method of claim 8 further including the step of aging said reformed weatherstrip whereby said reformed weatherstrip relaxes.

10. The method of claim 8 wherein said curved exterior surface of said fixture extends over at least 120°.

11. The method of claim 8 wherein said weatherstrip includes a slot adapted to receive a glass light and said fixture includes a projection which extends to a bottom of said slot when surfaces of said weatherstrip adjacent said slot are in contact with said curved exterior surface.

12. The method of claim 8 wherein said heating is achieved by an infrared heater.

13. The method of claim 8 wherein said cooling is achieved by water spray.

14. A method of reforming an edge seal, comprising the steps of:
providing a length of edge seal,
heating a portion of said edge seal,
providing a fixture having a curved exterior surface,
conforming said heated portion of said edge seal to at least a portion of said curved exterior surface of said fixture,
cooling said edge seal while in contact with said curved exterior surface of said fixture.

15. The method of claim 14 wherein said curved exterior surface of said fixture includes a curved projection.

16. The method of claim 14 further including the step of aging said reformed edge seal.

17. The method of claim 14 wherein said edge seal includes a first slot and a second, adjacent, oppositely directed slot.

18. The method of claim 14 wherein said curved exterior surface of said fixture extends over at least 120°.

19. The method of claim 14 wherein said cooling is achieved by water spray.

20. The method of claim 14 further including the step of extruding said length of edge seal.
